(19) United States
(12) Patent Application Publication
(10) Pub. No.: US 2009/0019103 A1
(43) Pub. Date: Jan. 15, 2009

(54) METHOD AND SYSTEM FOR PROCESSING A DATABASE QUERY

(76) Inventors: James Joseph Tommaney, Allen, TX (US); Robert J. Dempsey, Plano, TX (US); Phillip R. Figg, The Colony, TX (US); Patrick M. LeBlanc, McKinney, TX (US); Jason B. Lowe, Dallas, TX (US); John D. Weber, Plano, TX (US); Weidong Zhou, Trophy Club, TX (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/775,976

(22) Filed: Jul. 11, 2007

(51) Int. Cl. G06F 15/16; G06F 17/30; G06F 7/06

(52) U.S. Cl. 709/201; 707/3; 707/E17.015; 707/E17.032

(57) ABSTRACT

A method and system for processing a database query is described. One embodiment is a scalable, reconfigurable database query processing system comprising one or more director, user, and performance modules in a configuration that includes shared-nothing behavior of the modules and the distributed processing of primitives for resolving a database query in accordance with a column-oriented database architecture.

### RELATED APPLICATIONS

The present application is related to commonly owned and assigned application Ser. No. (unassigned), Attorney Docket No. CALP-004/00US, entitled “Method and System for Performing a Scan Operation on a Table of a Column-Oriented Database,” filed herewith.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to computer databases. In particular, but not by way of limitation, the present invention relates to methods and systems for processing database queries.

### BACKGROUND OF THE INVENTION

The ability to analyze significant amounts of data enables companies to take advantage of better decision making and better leverage a key asset: their data. Analysis of the data is typically provided through a data warehouse which provides On-Line Analytic Process (OLAP), Decision Support System (DSS), Business Intelligence (BI), or analytics behavior. The data is typically structured as tables made up of columns (fields) organized into rows and containing up to terabytes or petabytes of data and up to billions or trillions of rows. Request for analysis of the data is typically done through execution of a “query” or Structured Query Language (SQL) “select” statement. Addition or modification of the data via Data Manipulation Language (DML) or the structures containing the data via Data Definition Language (DDL) is accomplished through statements containing keywords including but not limited to ‘create table’ or ‘insert into’.

As data warehouses keep growing, the ability to read blocks of data from disks is not growing quickly enough to keep up with the increase of data. It is therefore apparent that there is a need in the art for an improved Query Processing System.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

One illustrative embodiment is a method for processing a database query in the form of a Structured Query Language (SQL) statement, the method comprising establishing a connection with a computer over a network; receiving a SQL statement from the computer over the network; analyzing the SQL statement to determine a set of data objects in a database that is required to process the SQL statement and to determine a sequence in which the data objects in the set of data objects are to be processed, the analyzing being performed in accordance with a column-oriented database architecture; analyzing the SQL statement further to determine a set of job steps to be performed in processing the SQL statement and to determine, for each data object in the set of data objects, at least one extent included in that data object, the at least one extent including at least one data block; associating a primitive with each data block in each extent; passing each primitive to one of a plurality of processing nodes, the at least one data block in each extent being passed to the same processing node, the primitives being distributed over a maximum number of available processing nodes, primitives associated with independent job steps being passed to their respective processing nodes substantially in parallel; determining, for each primitive, whether the associated data block is already resident in a random-access memory to avoid unnecessary accesses to secondary data storage; processing each primitive by accessing one or more records in the associated data block to produce a result; aggregating the results of the primitives to produce aggregated results; and returning the aggregated results to the computer over the network.

Another illustrative embodiment is a database query processing system comprising one or more director, user, and performance modules configured to process a database query.

These and other illustrative embodiments are described in further detail herein.

### BRIEF DESCRIPTION OF THE DRAWINGS

Various objects, advantages, and a more complete understanding of the present invention are apparent and more readily appreciated by reference to the following Detailed Description and to the appended claims when taken in conjunction with the accompanying drawings, wherein:

FIG. 1 illustrates a Query Processing System in a typical query environment consisting of a network, client computers, and in some cases a web server or application in accordance with an illustrative embodiment of the invention;

FIG. 2 illustrates a server in the Query Processing System in accordance with an illustrative embodiment of the invention;

FIG. 3 illustrates the modules used for one implementation of the present invention where each module includes software processes running on dedicated servers or blades and communicating with other modules via inter-process communication;

FIG. 4 illustrates additional software detail for one implementation of the present invention and describes the Director Module;

FIG. 5 illustrates additional software detail for the Director Module for one implementation of the present invention;

FIG. 6 illustrates additional software detail for one implementation of the present invention describing a User Module;

FIG. 7 illustrates additional software detail for one implementation of the present invention describing a Performance Module;

FIG. 8 illustrates one implementation of the present invention with multiple client connections connecting to one or more Director Modules, multiple User Modules, and multiple Performance Modules connected to a single storage device;

FIG. 9 illustrates one implementation of the present invention with multiple client connections connecting to one or more Director Modules, multiple User Modules, and multiple Performance Modules connected to multiple clustered or un-clustered storage devices;

FIG. 10 illustrates one implementation of the present invention detailing data flows between a User Module and multiple Performance Modules;

FIG. 11 describes a hardware platform to support one implementation of the present invention consisting of redundant connectivity and modules;

FIG. 12 is a flowchart describing the flow to process a Structured Query Language (SQL) query in a Query Processing System in accordance with an illustrative embodiment of the invention;

FIG. 13 is a flowchart describing a process for adding a User Module to a Query Processing System in accordance with an illustrative embodiment of the invention;

FIG. 14 is a flow chart describing a process for removing a User Module from a Query Processing System in accordance with an illustrative embodiment of the invention;

FIG. 15 is a flowchart describing a process for adding a Performance Module to a Query Processing System in accordance with an illustrative embodiment of the invention;

FIG. 16 is a flow chart describing a process for removing a Performance Module from a Query Processing System in accordance with an illustrative embodiment of the invention;

FIG. 17 is a flow chart describing a process for reconfiguring a User Module to a Performance Module in accordance with an illustrative embodiment of the invention;

FIG. 18 is a flow chart describing a process for reconfiguring a Performance Module to a User Module in accordance with an illustrative embodiment of the invention;

FIG. 19 is a flowchart describing a process for automatically eliminating partitions in accordance with an illustrative embodiment of the invention;

FIG. 20 is a flowchart describing a process for maintaining current summary information in accordance with an illustrative embodiment of the invention;

FIG. 21 is a flowchart describing a process for creating a table in accordance with an illustrative embodiment of the invention;

FIG. 22 is a flowchart describing a process for minimizing the rows of data returned to a database management system (DBMS) front-end system in accordance with an illustrative embodiment of the invention; and

FIG. 23 illustrates a block organization for storing data in accordance with an illustrative embodiment of the invention.

### DETAILED DESCRIPTION

The present invention is related to distributed database access of large data sets, associating that data in support of relational queries, and returning the results. In particular, but not by way of limitation, the present invention provides the ability to execute Structured Query Language (SQL) statements across significant data sets typically represented as logical tables consisting of columns and rows.

Embodiments of the present invention include methods to accelerate scans of large data sets by partitioning or splitting the data stored along field or column boundaries such that analysis of the data requiring that field or column can be accomplished without accessing non-required fields or columns. This embodiment includes hardware and software modules running specialized code such that additional modules can be added to provide for additional performance acceleration, and that software processing within the additional modules does not require additional processing to take place as the number of modules increases. The ability to add additional processing modules within a system without incurring additional peer module to peer module synchronization is described as “shared-nothing behavior.” This shared-nothing behavior of the modules allows for linear or near-linear acceleration of processing as the number of modules executing that process increases. Because performance modules do not store data within direct attached storage, but rather access external storage to read the data, the number of performance modules can be changed in a highly flexible manner without requiring redistribution of data as required by a system with direct attached storage.

The ability to add additional processing capability in a shared-nothing mode that offers linear or near-linear behavior allows for cost savings for database systems by allowing for growth with commodity hardware rather than specialized systems. The cost increase for adding additional processing nodes of the same configuration is generally linear. Increasing from two Performance Modules to four Performance Modules basically doubles the cost. This is in contrast to upgrading within a single server to allow for additional growth. The cost to implement twice the number of CPUs and memory within a single server typically results in greater than twice the price. Therefore, a shared-nothing system that allows for scaling through more of the same servers delivers business value through lower, more predictable costs.

The Query Processing System organizes its data on disk along column boundaries, so that data for each column can be read without accessing other column data. This specialized representation that stores data for each column separately also reduces the number of bytes of data required to resolve most SQL statements that access large data sets. This capability to reduce the bytes required accelerates processing directly for queries involving disk, but also reduces the memory required to avoid storing the data in memory. Storing the blocks in memory allows a query to be satisfied from memory rather than disk, dramatically increasing performance.

The combination of a scalable, shared-nothing architecture along with specialized storage capabilities that significantly reduce the number of data blocks required provides for performance gains larger than possible with either technology approach alone. Implementation of the specialized column data storage that allows for fewer data blocks required per Structured Query Language (SQL) statement accessing large data sets reduces the memory required per statement. The shared-nothing architecture allows for significantly larger memory to be delivered more cost effectively. The combination of larger system memory and smaller per-statement requirements delivers a significant performance upgrade by resolving more queries from memory rather than disk.

The size of data warehouse implementations increases over time based on additional data history, new data sources being included in analysis, or regulations that require a longer retention period. Existing data warehouse solutions become more reliant on disk behavior to access these larger and larger data sets.

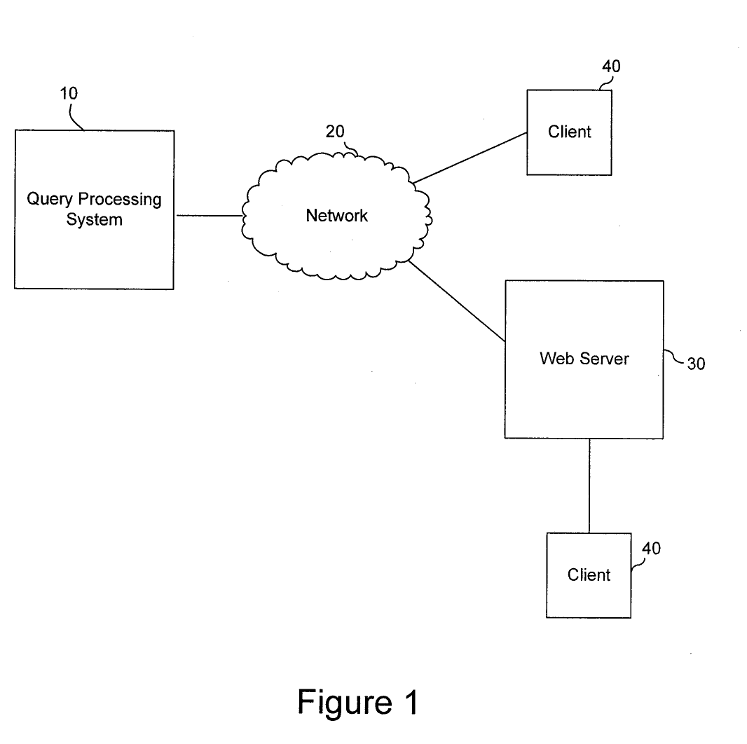

Referring now to the drawings, FIG. 1 illustrates the placement of the Query Processing System 10 in an illustrative user implementation. The Query Processing System 10 is a sub-network at a user's site and is connected to a network 20. The network 20 is either directly connected to client computers 40 or to a web server or application 30 which is connected to client computers 40.

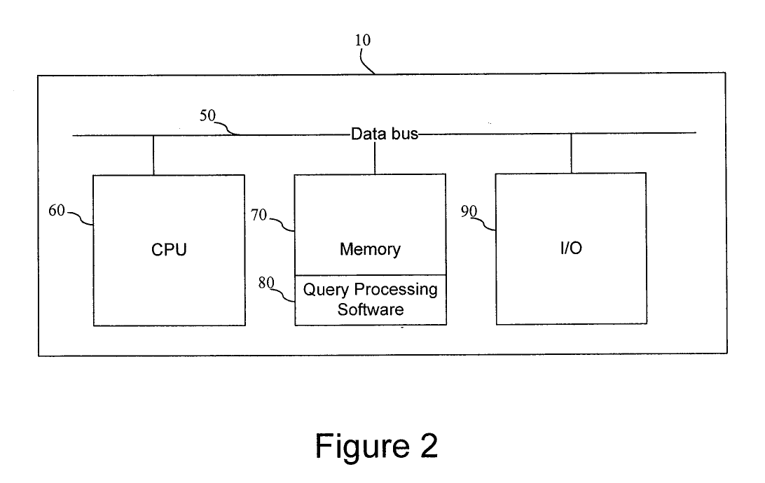

FIG. 2 illustrates a server in the Query Processing System in accordance with an illustrative embodiment of the invention. The Query Processing System 10 includes multiple servers that are running the Query Processing Software 80. In FIG. 2, Query Processing System 10 includes a server with a data bus 50, Central Processing Unit (CPU) 60, memory 70, and I/O ports 90. The Query Processing Software 80 resides in computer memory 70 in this embodiment.

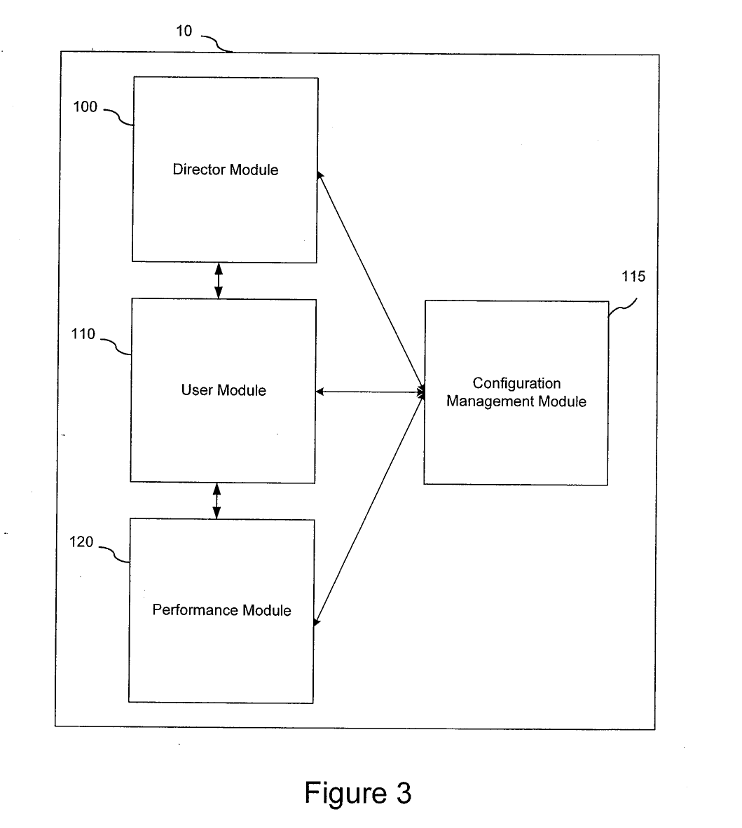

FIG. 3 represents the module organization for one implementation of the invention and includes one or more Director Modules 100, User Modules 110, and Performance Modules 120. For this implementation of the invention, the Director Module 100 is responsible for accepting connections and processing statements to support SQL, Data Manipulation Language (DML), or Data Definition Language (DDL) statements. This implementation includes a User Module 110 responsible for issuing requests to scan data sources and to aggregate the results. This implementation also includes multiple Performance Modules 120 responsible for executing scan operations against the columns required by the SQL statement. Subsets of each file are associated with a Performance Module 120 such that accesses to large files is distributed across all available Performance Modules 120. There can be multiple Director, User, or Performance Modules installed and running at any given point. A module is the combination of software and hardware running on a given server and blade. If the server or blade is executing processes for one module and then changes to run processes for another module, then that server can be said to become the new module. The software supports reconfiguring modules as needed to support demand. This function is performed by Configuration Management Module 115. In general, these modules can be implemented in hardware, firmware, software, or any combination thereof.

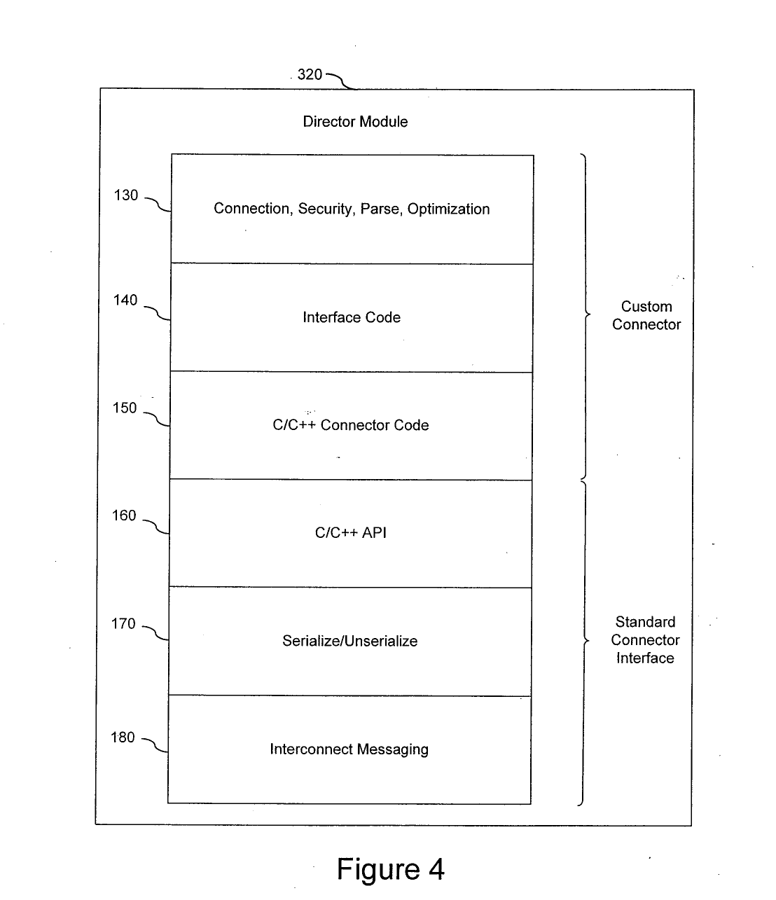

FIG. 4 illustrates additional software detail for one implementation of the present invention and describes a Director Module 320. The Director Module 320 represented in FIG. 4 is responsible for accepting connections from user applications and validating username and password combinations in order to validate the connection. SQL, DML, or DDL statements are accepted by Director Module 320 and are processed to resolve a number of items including the following: verify object names, verify privileges to access the objects, rewrite the statement to optimize performance, and determine effective access patterns to retrieve the data. This processing is handled by a connection, security, parse, optimization layer 130. Interface code 140 provides for a standard way to communicate with the connection, security, parse and optimization layer 130. C/C++ connector code 150 is created to access the interface code 140. The C++ API 160 layer represents a standard method of communicating with the underlying data access behaviors. The statements to be processed as well as the information about the connection are serialized via the serialize/unserialize 170 and passed through interconnect messaging 180 to a User Module responsible for executing the statement. Specialized interface software allows for the basic connection, security, parse, and optimization 130 to be accomplished by specialized software either written especially for this purpose, or by integration with an existing database package providing that functionality. In addition, Director Module 320 provides connection with the other modules of the present invention that execute additional work to support the statements. Examples of database packages that offer connection, security, parse, and optimization functionally and have the appropriate interface model include ORACLE, DB2, and MYSQL.

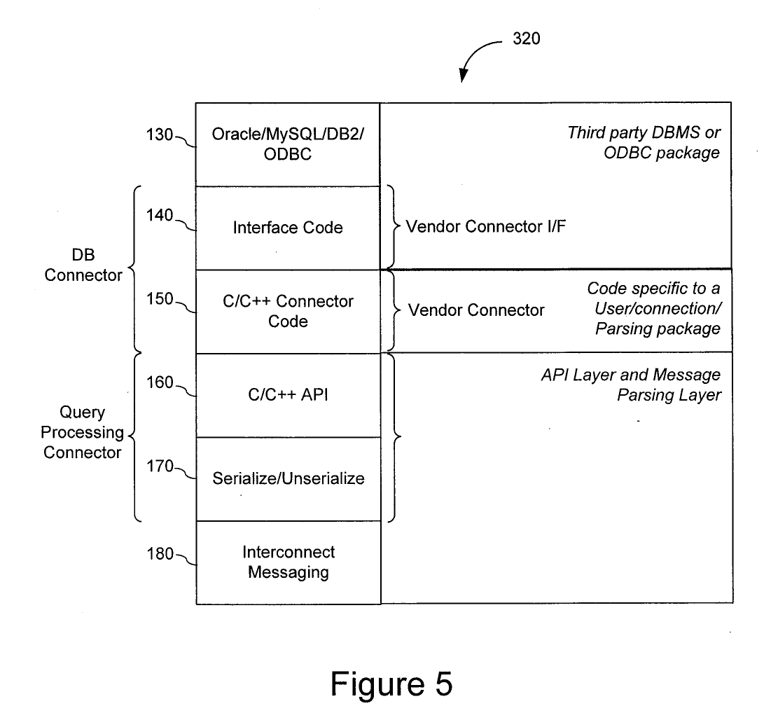

FIG. 5 illustrates additional software detail for the Director Module 320 for one implementation of the present invention. FIG. 5 shows functionality including user administration, connection services, and parsing/optimizing 130. A standard interface code 140 layer establishes the connection between the user/connection/parsing and the query processing API. Code is organized such that the C/C++ connector code 150 provides the “glue” to connect the software components and is structured such that that the code layer is as small as possible. Note that the connection, security, parse, optimization layer 130 layer does not store data. Customers can replace one implementation of the connection, security, parse, optimization layer 130 with a different implementation without migrating data.

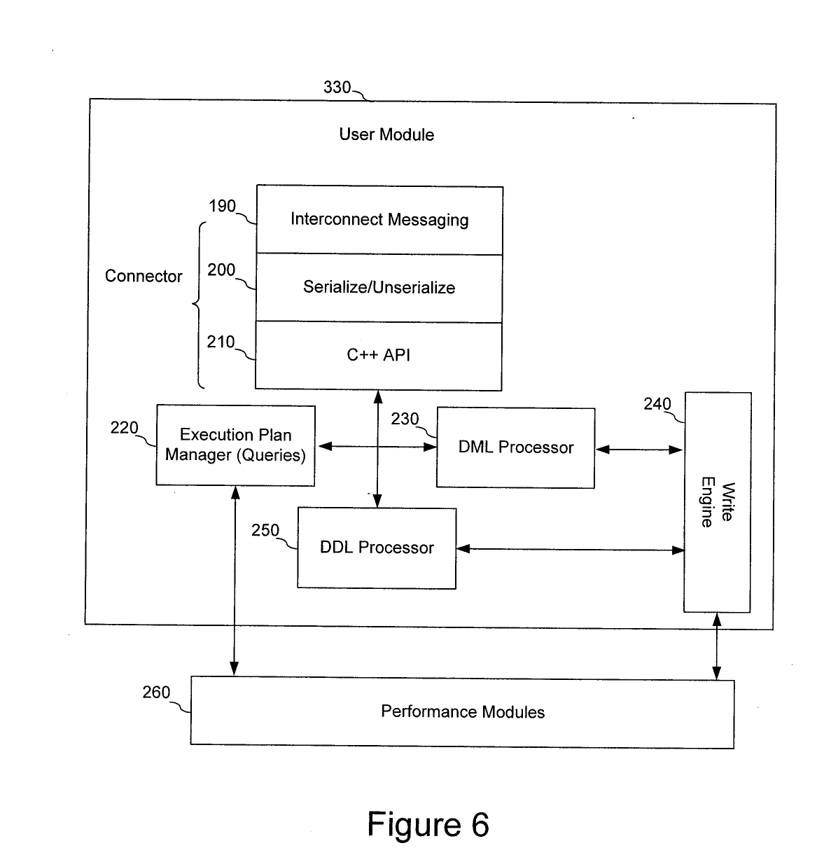

FIG. 6 illustrates additional software detail for one implementation of the present invention describing a User Module 330. User Module 330 represented in FIG. 6 is responsible for accepting the request to handle the statement and transfer the statement to dedicated software packages to handle query SQL statements via the execution plan manager 220, DDL statements via the DDL processor 250, or DML statements via the DML processor 230. The SQL statements that execute queries to access the data initiate primitive requests to the Performance Modules, which access the data sources. Statements that alter the data sources (DDL and DML) are processed through the write engine 240 that owns write access to the underlying data sources.

Executions of statements pass from the Director Module to the User Module through the connection layers (interconnect messaging 190, serialize/unserialize 200, and the User Module C++ API 210). The DDL processor makes calls to the write engine 240 to create the initial file allocation for all file types that can include column files, dictionary files, index tree files, or index list files as needed to support the DDL statement. Drop statements remove all required column, dictionary, index tree, or index list files as directed by the drop statement.

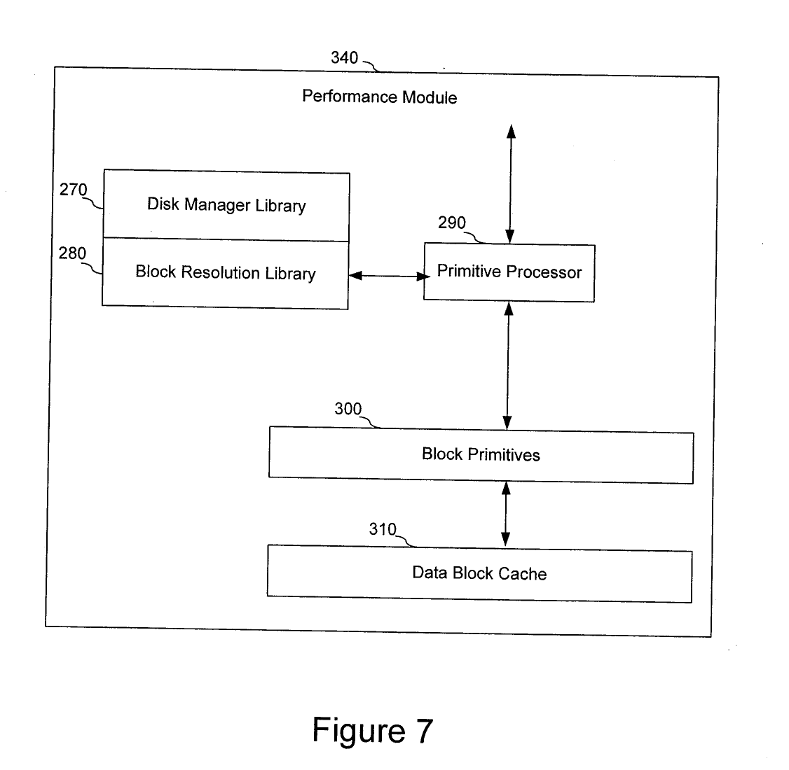

FIG. 7 illustrates additional software detail for one implementation of the present invention describing a Performance Module 340. Performance Module 340 represented in FIG. 7 is one implementation of the current invention that executes access to subsets of source data based on commands issued to each Performance Module 340. The request to provide for a filtered access to a portion of the data is herein described as a “primitive.” Required primitives to execute a scan of source data includes, but is not limited to the following: column, dictionary, index tree, or index list files. The primitive processor 290 is responsible for providing access to the block or blocks of data to be referenced, reading the data records specified, and applying any filters or aggregation that may be requested. The block primitives 300 components are the code objects that understand the formats of the files and apply appropriate filters to access the data. The data block cache 310 is the shared-nothing cache containing previously or recently accessed blocks of data to be processed. A Performance Module 340 includes software modules that execute primitive operations on subsets of a data field either from memory via the data buffer cache or from disk. The data buffer cache includes memory on each Performance Module 340 used to store blocks of data. A request for a block of data is resolved from the data buffer cache where possible and if found avoids reading the block of data from the disk. The data buffer cache is constructed so that all operations required to store or access a block of data take place without any coordination with other Performance Modules 340. The ability to expand by adding additional Performance Modules 340 in a shared-nothing manner allows the performance of the data buffer cache to scale in a linear or near-linear manner.

For this implementation of the current invention, each Performance Module 340 acts independently from other Performance Modules 340 and does not require synchronization activities. The primitive processor 290, block primitives 300, and data block cache 310 contain memory and structures not dynamically shared between Performance Modules 340. The disk manager library 270 and block resolution library 280 share information between the write engine 240 and each Performance Module 340 individually.

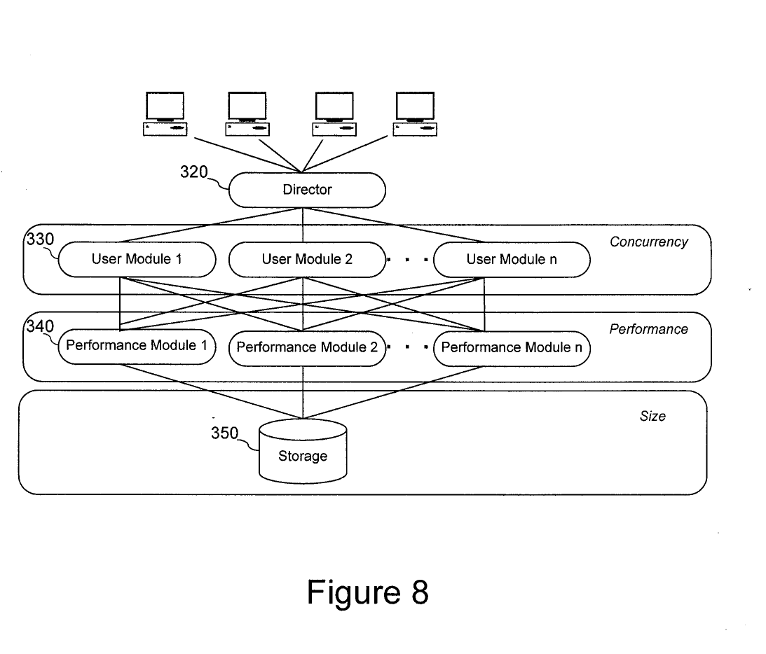

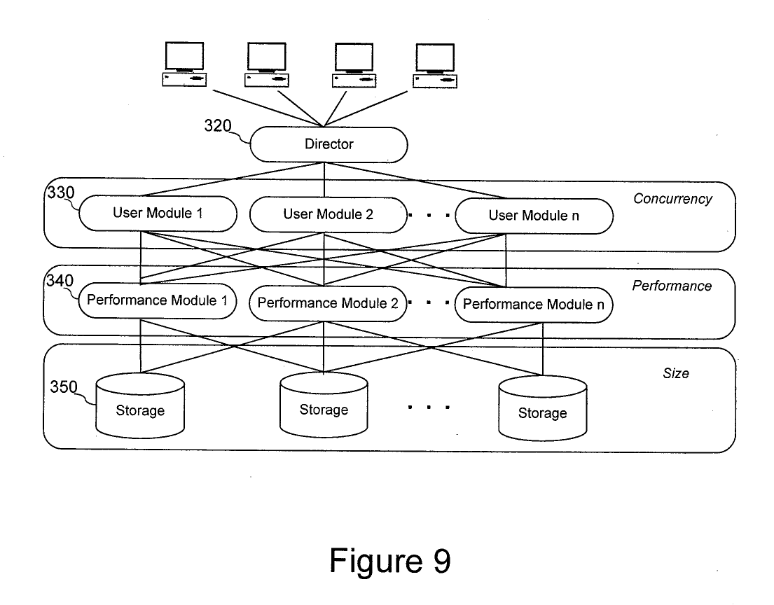

FIGS. 8 and 9 illustrate possible implementations of the current invention and demonstrate the flexibility of module deployment to satisfy specific business problems. The number of User Modules 330 can scale independently of other modules or storage to add additional concurrency (capacity to support simultaneous queries) of other modules or storage. The number of Performance Modules 340 can scale independently of other modules or storage to allow for additional data block cache 310 capacity or additional processing power. Although not illustrated, the number of Director Modules 320 can scale independently of other modules or storage to provide for redundancy or additional capacity for parsing or maintaining connections. In addition storage 350 can scale independently as well.

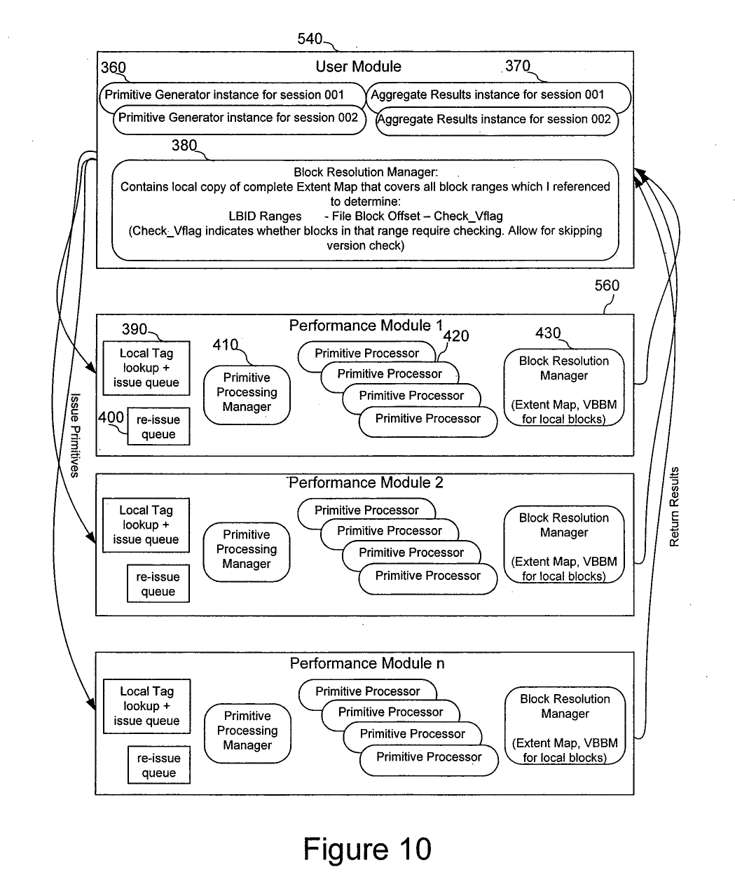

FIG. 10 illustrates process flow for one implementation of the current invention. The primitive generator 360 components of User Module 540 issue primitives on behalf of a query/connection to all available Performance Modules 560. The block resolution manager 380 components contains information about proper distribution of work to scan a file (source data), as well as information required to track changes to the source data files. Issue of the primitive is received by the primitive processing manager 410. The primitive processing manager 410 identifies whether the portions of the file required for each primitive are already resident within the data block cache 310 (see FIG. 7) by accessing the local tag lookup+issue queue 390. For primitive requests that require a read from disk, re-issue queue 400 allows for rescheduling the primitive until after the required data has been read from disk. The block resolution manager 430 is referenced as needed to provide for the correct version of the block consistent with a point in time. Results are returned from all Performance Modules 560 to the aggregate results 370 process running for that session.

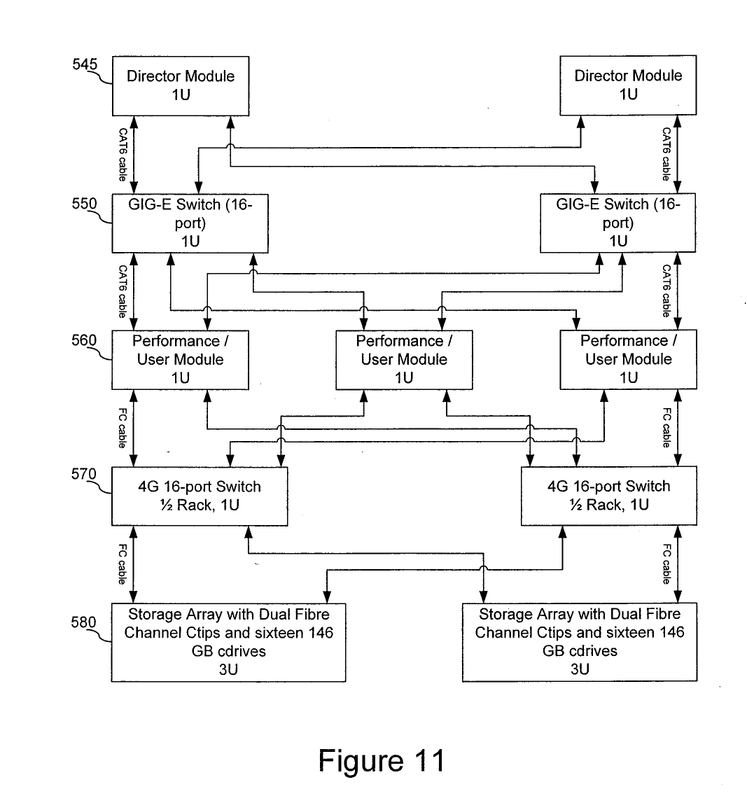

FIG. 11 illustrates one deployment implementation of the current invention providing for redundant modules, redundant networking, and redundant controllers. Servers have the installed software to execute any of these. The number of each type of module shown in FIG. 11 is merely illustrative. In other embodiments, different numbers of the various types of modules can be deployed. Based on the ability of User and Performance Modules to fail over for each other, three Performance/User Modules 560 allow for either User or Performance Module behavior depending on reading of a configuration parameter. Therefore a given User or Performance module can be removed from service as one module and go into service as another module. Based on this ability of User and Performance Modules to replace another module, a total of three Performance/User Modules 560 allows for one User and two Performance Modules to be implemented while still providing for a backup for the User Module if a failure takes place within that server. If a failure takes place in the single User Module, then one of the two Performance Modules is redeployed as a User Module. Components of the deployment implementation include the Director Modules 545, Gig-E Switches 550, Performance/User Modules 560, 4G 16-Port Switch 570 (fiber channel switches), as well as the storage array with dual fibre channel controllers and sixteen 146-GB drives 580.

Tables 1 and 2 below detail an extent map implementation of the current invention that provides for a configurable mapping of logical constructs (indexes, columns, or other files) to one or more files at the extent level. Each extent is made of a configurable extent size that includes possible values of 8 MB, 80 MB, or 800 MB, among other possible sizes. Each extent includes one or more data blocks. Additional information is persisted that stores either range, list, or hash values of the data within the extent.

TABLE 1
Extent Map Fields

| Field Name | Description |
|---|---|
| LBID_START | Starting point for a range of Logical Block Identifiers. |
| EXTENT_SIZE | Number of 1k extents in an allocation |
| OID | Object number, identifier that maps to an index tree, index list, |
| | dictionary, or column. |
| OID_Part | For partitioned objects, or columns larger than the maximum |
| | file size, the OID_Part allows for multiple files to be |
| | associated with one OID. For OIDs larger than the max |
| | filesize, OID_Part allows extension to multiple files. |
| OFFSET_START | Index to first 8k block in the extent. |
| HWM | High Water Mark, the index of the highest block written to within |
| | that file. |
| Low_value | Lowest value stored within the extent. |
| Lv_incl_flag | Indicate whether lowest value is inclusive, i.e. whether value |
| | in lowest_value field in included in the extent. |
| High_value | Highest value stored within the extent. |
| Hv_incl_flag | Indicate whether highest value is inclusive, i.e. whether |
| | value in highest_value field in included in the extent. |
| Hash_value | Value output from the hash operation for the data within the extent. |
| List_values | List of values contained within the extent. Declaration of the |
| | list is limited based on the size of this field. |

TABLE 2
Example Subset of Extent Map

| Lbid_Start | Extent_Size | OID | OID_Part | Offset_Start | HWM | low_value | Lv_incl_flag |
|---|---|---|---|---|---|---|---|
| 0 | 10 | 99 | 0 | 0 | 2 | 1 | Y |
| 10240 | 10 | 99 | 1 | 0 | | 5 | Y |
| 20480 | 10 | 99 | 1 | 10240 | | 5 | Y |
| 30720 | 10 | 99 | 1 | 20480 | 20980 | 5 | Y |

| Lbid_Start | high_value | Hv_incl_flag | hash_value | list_values |
|---|---|---|---|---|
| 0 | 5 | N | | |
| 10240 | 9 | N | | |
| 20480 | 9 | N | | |
| 30720 | 9 | N | | |

A token dictionary is a method by which variable-length strings can be stored, with an indirect access path to a position via a fixed-width column. This has a number of benefits other than potentially saving space. Fixed-width columns can be scanned more rapidly since the start position of each value is known in advance, and a token dictionary shared across columns is a critical performance criterion under the conditions where a join would be performed across the tokenized values. If the two columns share a domain, the underlying token values can be joined without requiring use of the dictionary lookup capabilities or converting both tokens to strings before comparing them to identify a match.

Some terminology in connection with token dictionaries is provided below.

Token: An address to a variable length record stored in a dictionary block. Addressing is sufficient to resolve to a specific file, block within the file, and position of the variable length record in the block.

Signature: The variable length record stored in the dictionary block.

Token Addressing Scheme: The pointer for a record in the dictionary file structure provides for an address that allows for accessing individual records. This token address includes the block location identified by the Logical Block Identifier (LBID) as well as the position within the block.

With this addressing scheme, after identifying the specific block, the OP/Ordinal Position value (or index into the block header) is used to probe the header information within the block to determine the starting offset within that block and the number of bytes for that specific signature. For large allocations, including strings spanning blocks, a continuation field contains a 6-byte pointer to a continuation block.

Tables can be partitioned either vertically or horizontally, and in both cases allow for partition elimination under some circumstances. Partitioning a table involves storing portions of the table separately such that part of the table can be read without reading other portions of the table. Horizontal partitioning involves dividing the table such that different groups of rows are stored in separate partitions. Vertical partitioning involves dividing the logical table into multiple, separate physically contiguous allocations, one for each column. Partition elimination describes the case where portions of the source data or file do not need to be accessed to resolve the search.

Vertical partition elimination takes place when the list of columns is less than all of the columns in all of the tables in the join or there are filters available using any column. Conversely, vertical partition elimination does not take place when the statement does not restrict the rows and the statement includes all columns (from all tables referenced).

Query Processing Software 80 column partitioning takes place automatically and transparently for all tables. The syntax to create a table, or select from a table, need only reference the table. Query Processing Software 80 decomposes the DDL, DML or SQL statements into the corresponding column objects automatically. Query Processing System 10 vertical partition elimination takes place automatically without requiring data-modeling expertise, build time for indices, or partition maintenance.

The primary structure mapping logical objects to files on disk is the extent map. The extent map records an object identifier (OID) for each column or index within the Query Processing System and maps that OID to one or more files within the disk subsystem. The extent map is also used to provide the mapping of data blocks to Performance Modules. The Logical Block Identifier (LBID) for the blocks in an extent is passed into a mathematical transformation that directs each extent into one of the Performance Modules. The transformation is deterministic based on the LBID and the number of Performance Modules such that any additional references to a block or extent are also submitted to the same Performance Module. This distribution is accomplished by a truncate operation on the LBID such that all blocks within an extent are grouped, and applying a modulo operation using the number of active Performance Modules to distribute the groups.

An implementation of the invention includes a process to update the extent map to provide the minimum and maximum values for each extent and, in some embodiments, other metadata associated with that extent. An implementation of the invention includes a process to update the extent map to provide the minimum and maximum values or other metadata for each extent. Given that metadata about the column, a number of extents may be able to be eliminated for a given search (partition/extent elimination). There are a number of data usage models where different column data is related to other columns. Given an order_date, a delivery_date, and a payment_date as columns on a table, for example, horizontal partitioning can take place for only one of the columns. The update of the extent map stores the minimum and maximum values and effectively allows partition elimination to take place for related columns (delivery_date and payment_date) that may be highly related to the order date. Equivalent partition elimination or performance tuning can only be accomplished in other systems by the creation of highly specialized copies of the data.

The ability for User Modules or Performance Modules to be dynamically added into the Query Processing System or removed from the system enables modules to take over processing previously done by other servers. For either a User or Performance Module, there are two software methods implemented, a take-offline method and a take-online method.

In this implementation, taking a Performance Module offline includes altering an input variable to the mathematical function that distributes blocks or extents to modules so that the number of modules is reduced by one. Upon altering that function, all subsequent requests to issue primitives to Performance Modules are sent to one fewer modules. Upon completion of any outstanding primitives, the Performance Module identified can be taken offline. Taking a Performance Module online involves increasing the number of modules passed into the mathematical function by one so that primitives are sent to additional modules.

Taking a User Module offline is a two-step process. First, no additional SQL statements or connections are sent to the User Module. Upon completion of any currently running statements, the User Module is taken offline. Taking a User Module online involves adding the module into the pool of User Modules so that a portion of queries are assigned to that module.

The Query Processing System interfaces with functionality provided by the Director Module that may be implemented with different software programs. The interface model with the Director Module is table oriented, that is the Director Module software understands a construct from which it can select, insert, update, or delete rows. The ability to execute the select, insert, update or delete behavior is done within the Query Processing System. The representation of a table with select, insert, update, and delete behavior is relatively common within database systems in general. The Query Processing System uses the standard table-oriented representation of data; however, it uses the additional filters that are present within the SQL statement and applies all possible filters prior to returning rows. Individual table filters are applied as well as filters on any table or tables that impact the rows returned from any table. This capability to represent a table-oriented interface model yet apply filters from other tables allows for reduced database operations including the number of rows that may be required to be read or returned to the Director Module.

The ability to provide for high performance with different Director Module software components allows for significant flexibility for customers who prefer a specific vendor. The preference of a specific vendor may be related to customer's familiarity with a given product or may be related to specific features or functions implemented in the vendor software running on the Director Module.

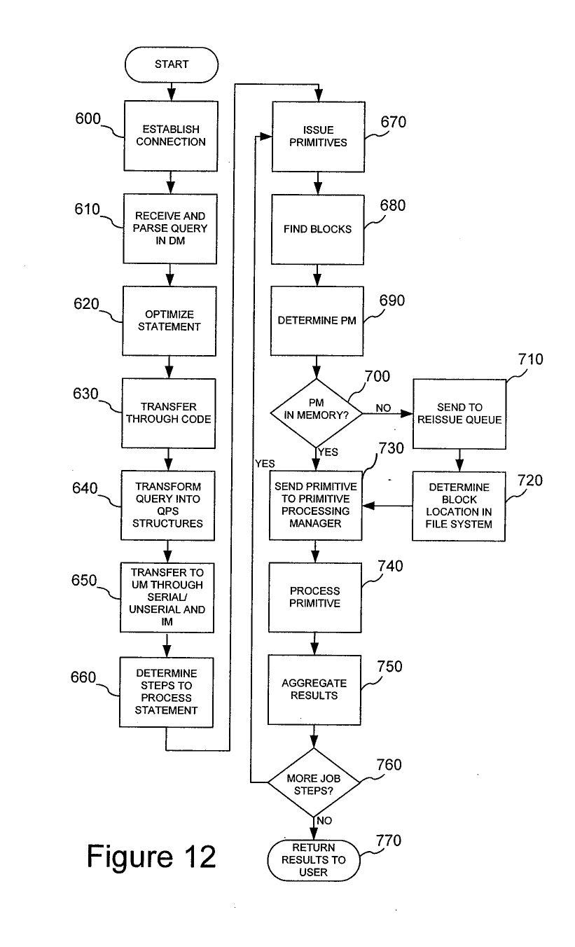

FIG. 12 is a flowchart illustrating the execution of a query (select SQL statement) within the Query Processing System 10 in accordance with an illustrative embodiment of the invention. Within the Director Module 100, establish the connection at 600. Receive and parse the initial query at 610. Optimize the statement at 620. Pass information through interface code and C/C++ connector code at 630. Transform query information into Query Processing Software structures in the C/C++ API at 640. Pass the structures in a message through the serialize/unserialize 170 and interconnect messaging 180 to the User Module 110 for processing at 650.

Within the User Module 110, the message containing the structures passes through interconnect messaging 180 and serialize/unserialize 170 at 650. The C++ API passes the structures to the appropriate software module for processing. The execution plan manager 220 receives select statements and determines the steps required to process the statement at 660. The primitive generator within the execution plan manager 220 issues as many primitives as required for one or more job steps to the Performance Module 120 at 670. The block resolution manager is referenced to find all of the appropriate blocks for each object at 680. The LBID for each primitive is passed into a mathematical operation that determines the appropriate Performance Module 120 at 680.

The Performance Module 120 determines whether the block of data is already in memory within the local tag lookup+issue queue at 700. If the block is available in memory, the primitive is sent to the primitive processing manager 410 at 730. If the block is not available in memory, the block requested from disk and the primitive is sent to the re-issue queue at 710. The block resolution manager determines the location of the requested block of data within the file system at 720. The primitive processor processes the primitive to find any requested records at 740. Results are returned to the appropriate aggregate results within the User Module 110 at 750.

The User Module 110 aggregates the results at 750. The User Module 110 determines if there are more job steps to be processed at 760. If there are more job steps, the process flow continues at step 670. If there are no more job steps, the results are returned to the user.

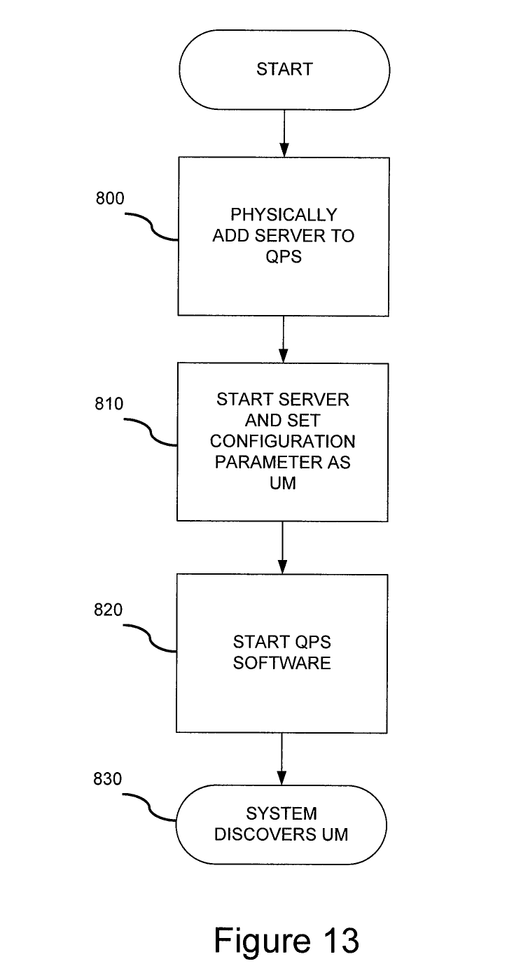

FIGS. 13 through 18 are flowcharts illustrating different ways of reconfiguring the Query Processing System in accordance with an illustrative embodiment of the invention.

There are multiple options possible in reconfiguring the Query Processing System:
Add a User Module 110 to the system;
Add a Performance Module 120 to the system;
Remove a User Module 110 from the system; and
Remove a Performance Module 120 from the system.

In addition there are combinations of the above steps that allow for converting a server from one module type to another;
Reconfigure a User Module 110 as a Performance Module 120; and
Reconfigure a Performance Module 120 as a User Module 110.

FIG. 13 illustrates the method steps involved in adding a User Module 110 in accordance with an illustrative embodiment of the invention. At 800, physically add the server with installed software to the Query Processing System 10 and connect to the other modules and disk. Start the server and set a configuration parameter indicating the server should run as a User Module 110 at 810. At 820, start the Query Processing Software 80 on the new module. At 830, the Query Processing System 10 discovers the newly started software and adds the User Module 110 into the pool of User Modules so that new connections can be sent to the newly started User Module 110.

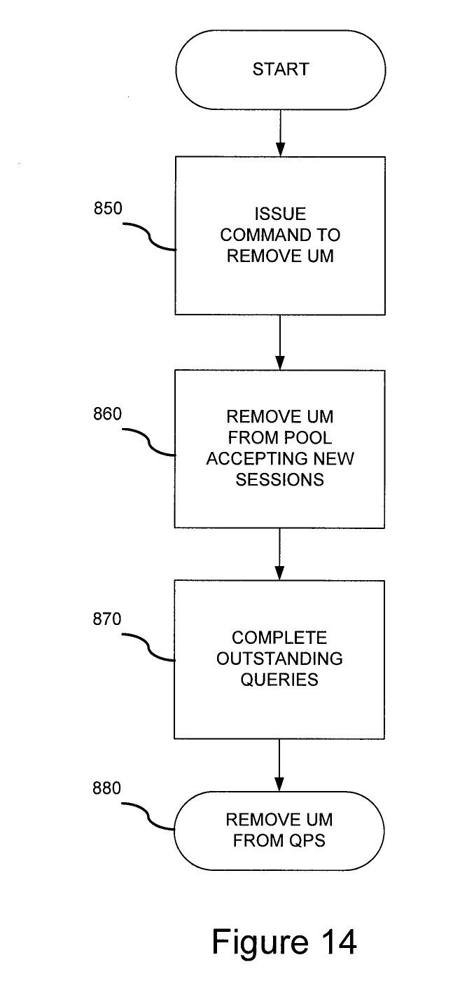

FIG. 14 illustrates the method steps involved in adding a User Module 110 in accordance with an illustrative embodiment of the invention. At 850, issue a command to the Query Processing System 10 to remove a designated User Module 110 from the system. The User Module 110 is removed from the pool of modules accepting new sessions at 860. At 870, upon completing any outstanding queries, the designated User Module 110 indicates that it is removed from the system. At 880, the designated module is removed from the system and can be dedicated for other purposes.

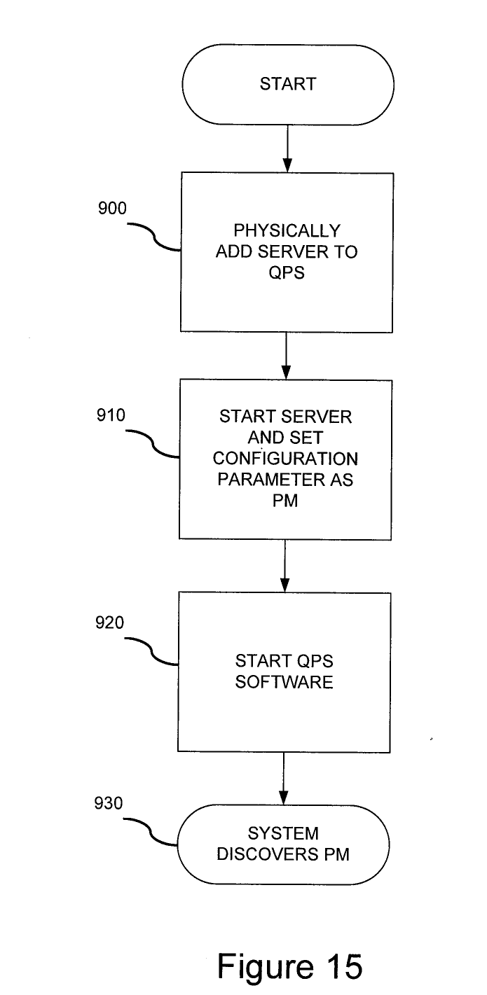

FIG. 15 illustrates the method steps involved in adding a Performance Module 120 in accordance with an illustrative embodiment of the invention. At 900, physically add the server with installed software to the Query Processing System 10 and connect appropriate connectivity to the other modules and disk. Start the server and set a configuration parameter indicating the server should run as a Performance Module 120 at 910. Start the Query Processing Software on that module at 920. At 930, the system discovers the newly started software and changes the mathematical operation within the Primitive Generator 360 so that the primitives are distributed to one additional Performance Module 120.

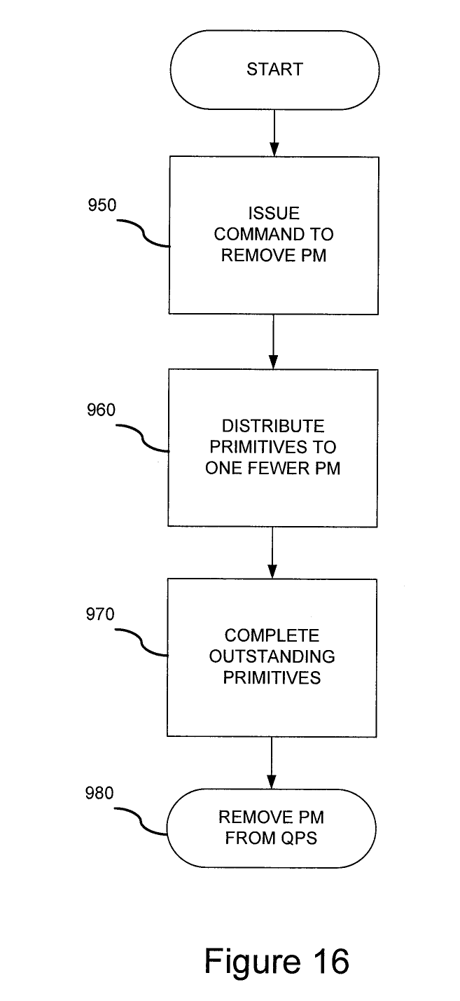

FIG. 16 illustrates the method steps involved in removing a Performance Module 120 in accordance with an illustrative embodiment of the invention. At 950, issue a command to the Query Processing System 10 to remove a designated Performance Module 120 from the system. The mathematical operation within the primitive generator 360 is modified such that the primitives are distributed to one fewer Performance Modules 120 at 960. Upon completing any outstanding primitive operations, the designated Performance Module 120 indicates that it is removed from the system at 970. At 980, the designated module is removed from the system and can be dedicated for other purposes.

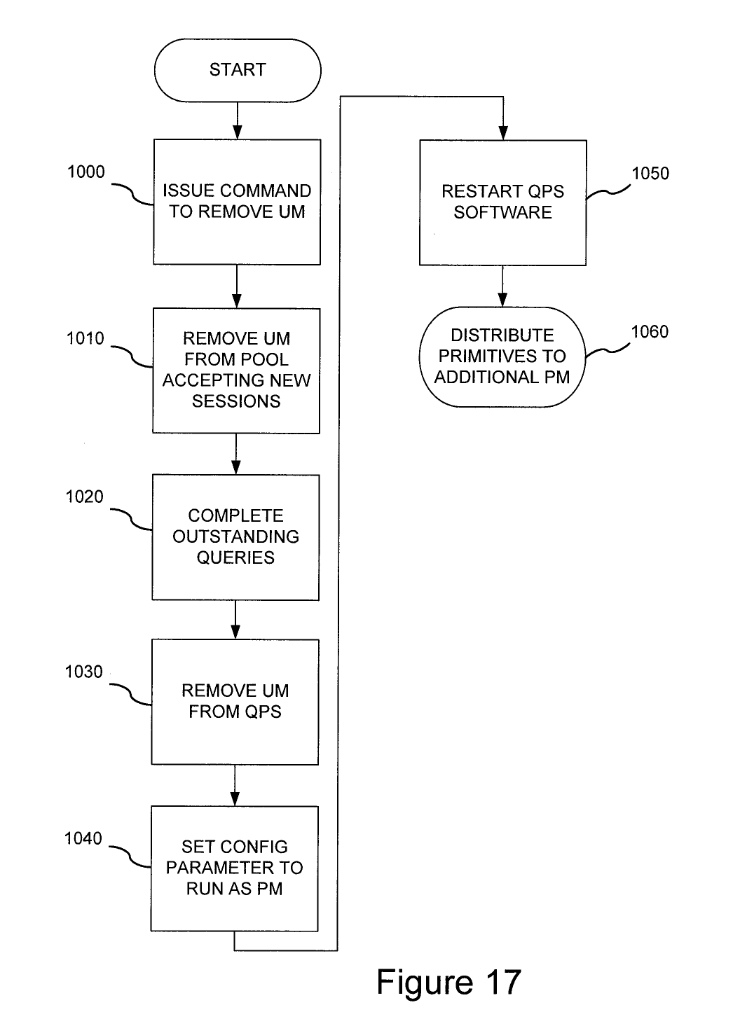

FIG. 17 illustrates the method steps to reconfigure a User Module 110 as a Performance Module 120 in accordance with an illustrative embodiment of the invention. At 1000, issue a command to the Query Processing System 10 to remove a designated User Module 110 from the system. The User Module 110 is removed from the pool of modules accepting new sessions at 1010. Upon completing any outstanding queries at 1020, the designated User Module 110 indicates that it is removed from the system at 1030. At 1040, set a configuration parameter indicating the server should run as a Performance Module 120. Restart the Query Processing Software 80 on that module at 1050. The system discovers the newly started software and changes the mathematical operation within the primitive generator 360 so that the primitives are distributed to one additional Performance Module 120 at 1060.

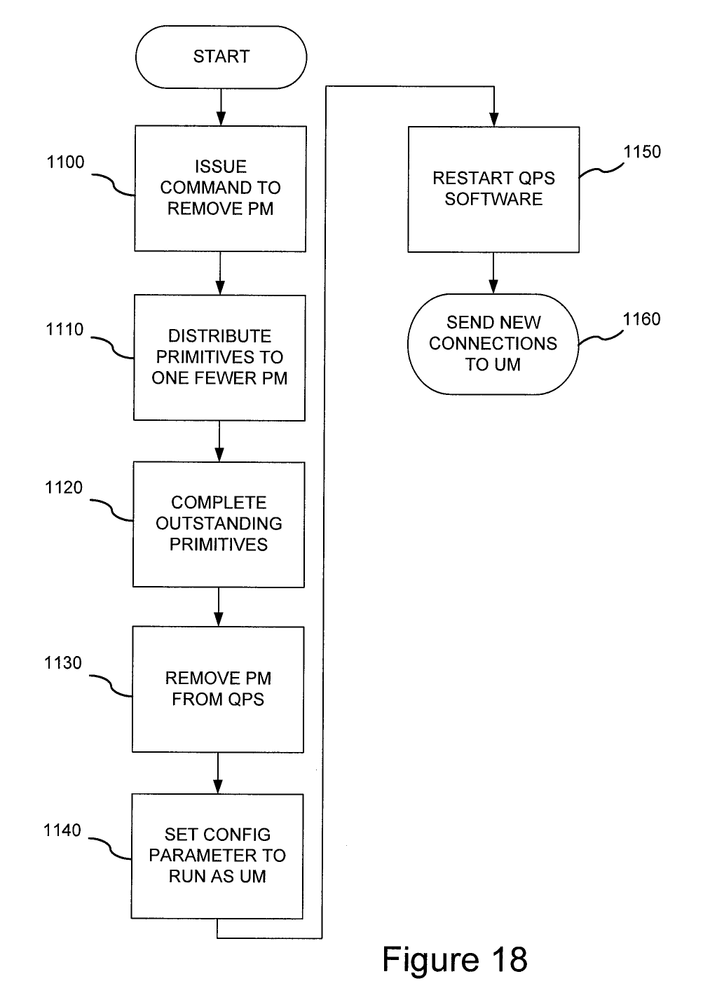

FIG. 18 illustrates the method steps to reconfigure a Performance Module 120 as a User Module 110 in accordance with an illustrative embodiment of the invention. At 1100, issue a command to the Query Processing System 10 to remove a designated Performance Module 120 from the system. At 1110, the mathematical operation within the primitive generator 360 is modified such that the primitives are distributed to one fewer Performance Modules 120. Upon completing any outstanding primitive operations at 1120, the designated Performance Module 120 indicates that it is removed from the system at 1130. At 1140, set a configuration parameter indicating the server should run as a User Module 110. Restart the Query Processing Software 80 on that module at 1150. At 1160, the system discovers the newly started software and adds the User Module 110 into the pool of User Modules 110 so that new connections can be sent to the newly started User Module 110.

Note that the methods shown in FIGS. 13 through 18 do not require that Query Processing System 10 be taken out of service. Rather, Query Processing System 10 remains capable of receiving and processing database queries throughout the various reconfigurations described above.

There are two process flows that together enable automatic extent elimination for multiple columns of data. One process flow is responsible for storing summary information about the values stored within an extent into the extent map structure, including, but not limited to, the minimum and maximum values of data in the applicable extent. This process also identifies the case where an extent does not need to be referenced to resolve a query. The second process flow identifies when changes have occurred to one or more data blocks within an extent and resets the summary information for that extent in the extent map so that the summary information can be updated during a subsequent scan operation against that extent.

Recording the summary information about the values existing in an extent, including the minimum and maximum values for an extent, occurs during an operation that scans the blocks that make up the extent. As part of any ongoing scan operation that includes all of the blocks within an extent, the query engine can use the existing scan operation to gather the information. The gathered summary information is then stored within the extent map.

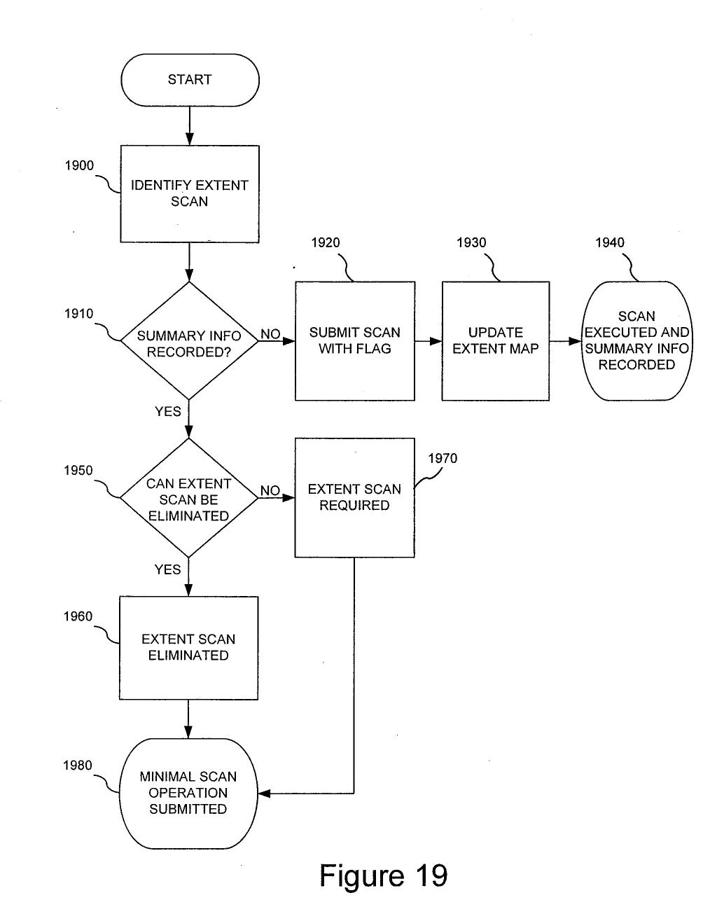

FIG. 19 illustrates the method steps involved in recording the summary information about the values within an extent. At 1900, identify the extent scan within the User Module 110. A column scan operation is identified as included to resolve a query. The column scan operation includes one or more extents within the scan operation. At 1910, the User Modules determines whether the summary information has been recorded for the extent. The summary information is available to evaluate extent scan elimination. At 1950, a check occurs whereby the values required for the query are evaluated against the extent summary information to determine whether a scan of the blocks within an extent can be eliminated. If the summary information about the values in an extent indicates that a scan operation is not required for that extent, the extent is eliminated from the scan operation at 1960. If the summary information about the values in an extent indicates that the scan operation is required, that extent is included in the scan operation at 1970. The minimal scan operation is submitted at 1980. If the summary information is not recorded for one or more extents at 1910, a required scan operation will also provide the summary values for those extents. A scan operation with a predetermined flag set is submitted for each such extent at 1920. As part of the scan operation initiated at 1920, the summary information about the values stored in the column is identified. The summary information values are stored within the extent map structure at 1930. At 1940, the required scan is executed and the summary information is recorded.

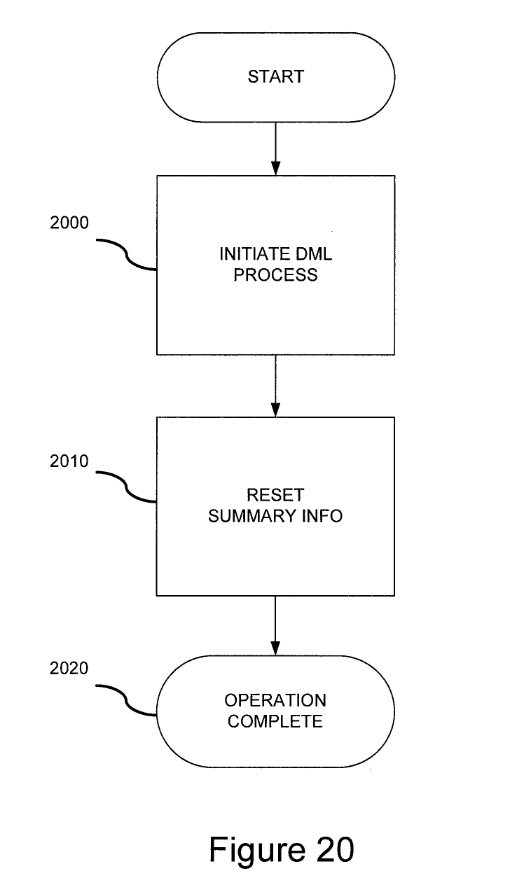

FIG. 20 illustrates the method steps involved in keeping the summary information current in accordance with an illustrative embodiment of the invention. At 2000, initiate a DML process. The DML Processor 230 requests an insert, update, or delete operation against one or more extents. At 2010, the summary information in the extent map associated with the affected extents is reset. If a block of data changes within an extent, the summary information is recorded when the extent map is cleared. The summary information is updated when a subsequent query initiates a scan against the extent. The operation is complete at 2020. The summary information has been cleared if one or more blocks within the extent have changed.

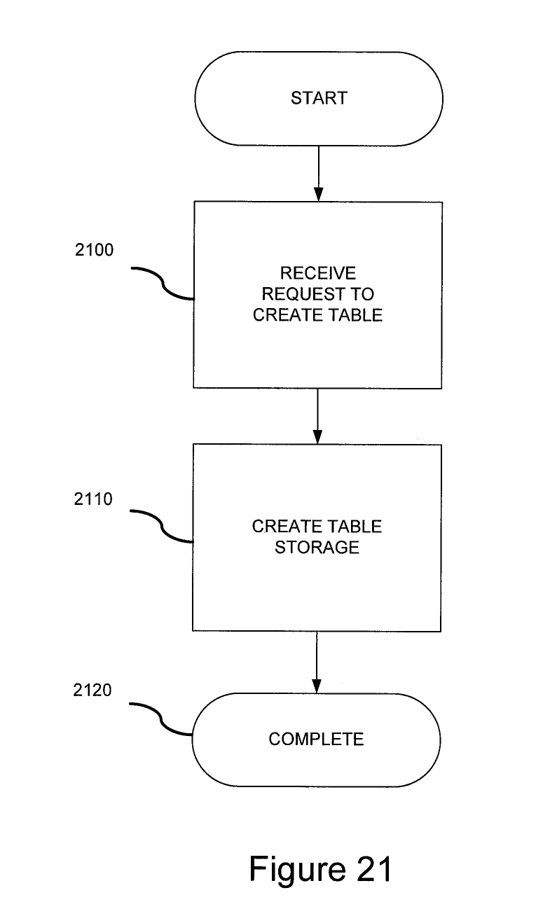

FIG. 21 describes the process to create a table in the system while establishing all of the objects to allow for storing the data as well as providing the interface between the systems (a table-oriented interface) in accordance with an illustrative embodiment of the invention. The table storage consists of a plurality of files containing column data within the disk storage that enables the table-oriented interface to interact with any of a plurality of different front-end database management systems. At 2100, the Query Processing System 10 receives a request to create a table. The table storage is created at 2110. The process terminates at 2120.

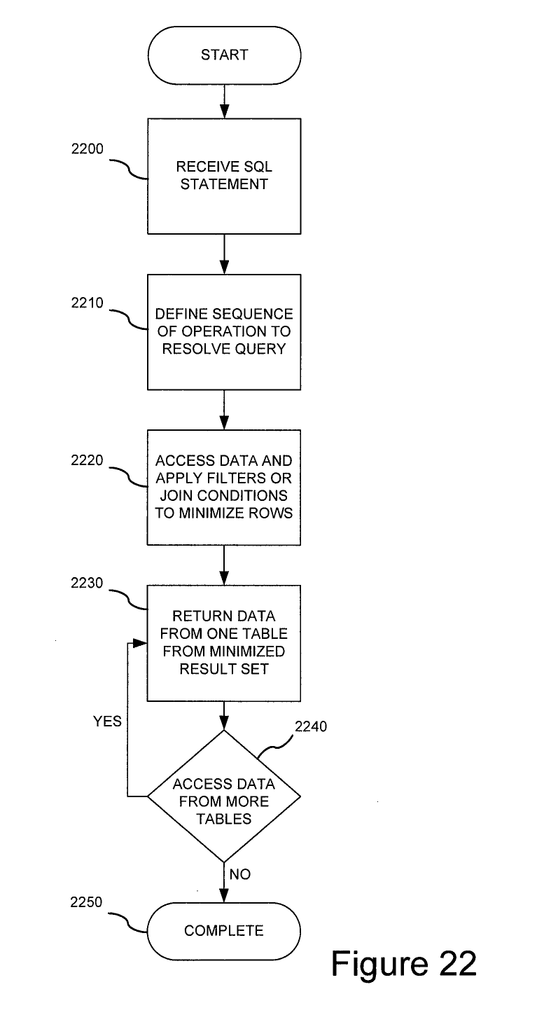

FIG. 22 describes the process flow that allows for iterative application of restrictions based on filters and joins in accordance with an illustrative embodiment of the invention. The method shown in FIG. 22 minimizes the number of rows returned in response to a query, wherein the SQL statement includes a join operation joining a first table and a second table and the SQL statement also includes a filtering operation of the first table. At 2200, the Query Processing System 10 receives a SQL statement. The Query Processing System 10 defines the sequence of operation to resolve the query at 2210 and accesses data and applies filters or join conditions to minimize the number of rows at 2220. The data is returned at 2230. If more data is needed from more tables at 2240, return the additional data at 2230. If more data is not needed, the query is complete at 2250. Note that, in FIG. 22, the filtering operation is applied to both the first and second tables to minimize the number of rows returned in response to the query.

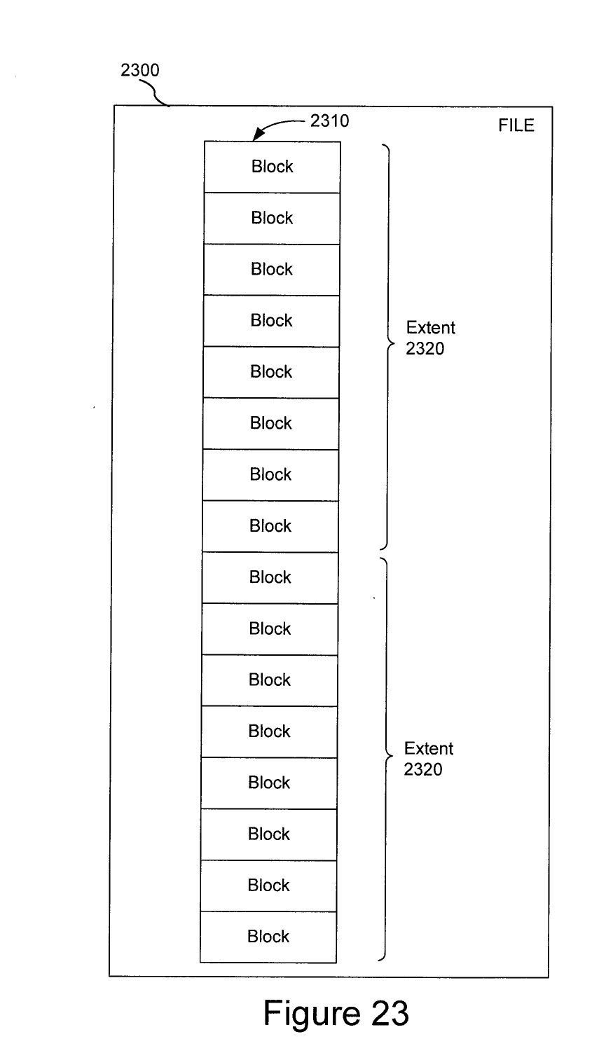

FIG. 23 illustrates the block organization for storing data in support of the column-oriented behavior. File 2300 includes blocks of data 2310. The data is located according to an offset record instead of a Row ID that is typical of many database systems. This elimination of the need to store a row identifier within the table or column reduces both the storage required and the processing required to read the records from disk. The types of data and the entries per block are shown in Table 3.

TABLE 3
Records per Block by Type

| | Storage | Entries |
|---|---|---|
| Type | Boundary | Per Block |
| TINYINT, CHAR(1) | 1-byte | 8192 |
| SMALLINT, CHAR(2) | 2-byte | 4096 |
| MEDINT | 4-byte | 2048 |
| INT, FLOAT, CHAR(3-4), DECIMAL(5-9) | 4-byte | 2048 |
| DATE | 4-byte | 2048 |
| BIGINT, DOUBLE, CHAR(5-8), | 8-byte | 1024 |
| DECIMAL(10-18) | | |
| DATETIME | 8-byte | 1024 |
| CHAR(>8), VARCHAR(>8), | 8-byte | 1024 |
| DECIMAL(>18) | (Token) | |
| CLOB, BLOB | 8-byte | 1024 |
| | (Token) | |

Within the Query Processing System index structure, lists of rows associated with an indexed value can span multiple blocks. The index list block structures can contain multiple pointers to other blocks that continue the list of associated rows. The use of multiple pointers allows for a scan of a large list to be parallelized by the distributed Performance Modules 120 of the Query Processing System 10.

To maximize storage efficiency of the data values within the fixed length structures, the Query Processing System 10 encodes special characters for each data type allowing for representation of null and empty rows without requiring additional storage. Encoded values are shown in Table 4.

TABLE 4
Encoded Values

| | | | Total Storage |
|---|---|---|---|
| Type | Empty Bit Identifier - hex | Empty Row Identifier - hex | Boundary |
| TINYINT | 80 | 81 | 1-byte |
| CHAR(1) | FE | FF | 1-byte |
| SMALLINT | 8000 | 8001 | 2-byte |
| CHAR(2) | FFFE | FFFF | 2-byte |
| VARCHAR(1) | FFFE | FFFF | 2-byte |
| DECIMAL(1-4) | 8000 | 8001 | 2-byte |
| (+/−9999) | | | |
| MEDINT/INT | 80000000 | 80000001 | 4-byte |
| FLOAT | FFAAAAAA | FFAAAAAB | 4-byte |
| CHAR(3-4) | FFFFFFFE | FFFFFFFF | 4-byte |
| VARCHAR(2-3) | FFFFFFFE | FFFFFFFF | |
| DECIMAL(5-9) | 80000000 | 80000001 | 4-byte |
| (+/−999999999) | | | |
| DATE | FFFFFFFE | FFFFFFFF | 4-byte |
| BIGINT | 8000000000000000 | 8000000000000001 | 8-byte |
| DOUBLE | FFAAAAAAAAAAAAAA | FFAAAAAAAAAAAAAB | 8-byte |
| VARCHAR(4-7) | FFFFFFFFFFFFFFFE | FFFFFFFFFFFFFFFF | |
| CHAR(5-8) | FFFFFFFFFFFFFFFE | FFFFFFFFFFFFFFFF | 8-byte |
| DECIMAL(10-18) | 8000000000000000 | 8000000000000001 | 8-byte |
| DATETIME | FFFFFFFFFFFFFFFE | FFFFFFFFFFFFFFFF | 8-byte |
| CHAR(>8), | FFFFFFFFFFFFFFFE | FFFFFFFFFFFFFFFF | 8-byte (Token) |
| VARCHAR(>7), | | | |
| DECIMAL(>18) | | | |

In conclusion, the present invention provides, among other things, a method and system for processing a database query. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for processing a database query in the form of a Structured Query Language (SQL) statement, the method comprising:
establishing a connection with a computer over a network;
receiving a SQL statement from the computer over the network;
analyzing the SQL statement to determine a set of data objects in a database that is required to process the SQL statement and to determine a sequence in which the data objects in the set of data objects are to be processed, the analyzing being performed in accordance with a column-oriented database architecture;
analyzing the SQL statement further to determine a set of job steps to be performed in processing the SQL statement and to determine, for each data object in the set of data objects, at least one extent included in that data object, the at least one extent including at least one data block;
associating a primitive with each data block in each extent;
passing each primitive to one of a plurality of processing nodes, the at least one data block in each extent being passed to the same processing node, the primitives being distributed over a maximum number of available processing nodes, primitives associated with independent job steps being passed to their respective processing nodes substantially in parallel;
determining, for each primitive, whether the associated data block is already resident in a random-access memory to avoid unnecessary accesses to secondary data storage;
processing each primitive by accessing one or more records in the associated data block to produce a result;
aggregating the results of the primitives to produce aggregated results; and
returning the aggregated results to the computer over the network.

2. The method of claim 1, wherein the result of at least one primitive is passed to a subsequent processing task in the database query processing system.

3. The method of claim 1, further comprising:
adding additional processing resources for performing the analyzing the SQL statement further, the associating, the passing, the aggregating, and the returning while simultaneously maintaining a capability of processing new database queries.

4. The method of claim 1, further comprising:
reducing processing resources for performing the analyzing the SQL statement further, the associating, the passing, the aggregating, and the returning while simultaneously maintaining a capability of processing new database queries.

5. The method of claim 1, further comprising:
adding additional processing resources for performing the determining and the processing while simultaneously maintaining a capability of processing new database queries.

6. The method of claim 1, further comprising:
reducing processing resources for performing the determining and the processing while simultaneously maintaining a capability of processing new database queries.

7. The method of claim 1, further comprising:
reconfiguring processing resources configured to perform the analyzing the SQL statement further, the associating, the passing, the aggregating, and the returning to instead perform the determining and the processing while simultaneously maintaining a capability of processing new database queries.

8. The method of claim 1, further comprising:
reconfiguring processing resources configured to perform the determining and the processing to instead perform the analyzing the SQL statement further, the associating, the passing, the aggregating, and the returning while simultaneously maintaining a capability of processing new database queries.

9. The method of claim 1, wherein the database includes:
a plurality of column files corresponding to a table, each column file containing one or more fixed-length records so as to eliminate use of a row identifier in accessing records;
a token within a particular column file in the plurality of column files, the token pointing to a data value stored in a dictionary data structure external to the particular column file, the dictionary data structure being capable of storing variable-length data values;
an indexing structure including a plurality of index blocks, at least one index block in the plurality of index blocks including multiple pointers pointing to other index blocks in the plurality of index blocks to enable parallel scanning, by the plurality of processing nodes, of a data set associated with the at least one index block; and
for each of a plurality of fixed-length-record types, an associated predetermined code value to indicate a null row in the table and an associated predetermined code value to indicate an empty row in the table, each predetermined code value occupying the same amount of space within a column file as a fixed-length record of the fixed-length-record type with which that predetermined code value is associated.

10. The method of claim 9, wherein a plurality of tokens point to a single variable-length data value in the dictionary data structure.

11. The method of claim 1, wherein the SQL statement includes a join operation joining a first table and a second table and the SQL statement also includes a filtering operation on the first table, each of the first and second tables including rows and columns of data, the method further comprising:
creating, prior to receiving the SQL statement from the computer over the network, a table-oriented interface for each of the first table and the second table using a create-table statement;
minimizing the number of rows retrieved from each of the first and second tables by applying the filtering operation to both the first and second tables; and
executing the join operation between the first and second tables without discarding any rows from either table that were not already discarded as a result of applying the filtering operation to both the first and second tables.

12. The method of claim 11, wherein the table-oriented interface is capable of interacting with any of a plurality of different front-end database management systems.

13. A database query processing system, comprising:
a plurality of servers, each server in the plurality of servers being configured to operate as at least one of:
a director module configured to:
establish a connection with a computer over a network;
receive a Structured Query Language (SQL) statement from the computer over the network; and
analyze, in accordance with a column-oriented database architecture, the SQL statement to determine a set of data objects in a database that is required to process the SQL statement and to determine a sequence in which the data objects in the set of data objects are to be processed;
a user module configured to:
analyze the SQL statement further to determine a set of job steps to be performed in processing the SQL statement and to determine, for each data object in the set of data objects, at least one extent included in that data object, the at least one extent including at least one data block;
associate a primitive with each data block in each extent; and
pass each primitive to one of a plurality of performance modules, the at least one data block in each extent being passed to the same performance module, the primitives being distributed over a maximum number of available performance modules, primitives associated with independent job steps being passed to their respective performance modules substantially in parallel; and
a performance module configured to:
determine, for each primitive, whether the associated data block is already resident in a random-access memory to avoid unnecessary accesses to secondary data storage; and
process each primitive by accessing one or more records in the associated data block to produce a result;
wherein the user module is configured to aggregate the results of the primitives to produce aggregated results and to return the aggregated results to the computer over the network.

14. The database query processing system of claim 13, wherein the user module is configured to pass the result of at least one primitive to a subsequent processing task in the database query processing system.

15. The database query processing system of claim 13, further comprising:
a configuration management module to manage the configuration of each server in the plurality of servers to operate as at least one of a director module, a user module, and a performance module, the configuration management module being configured, without the database query processing system being taken off-line, to perform at least one of:
adding a user module to the database query processing system;
removing a user module from the database query processing system;
adding a performance module to the database query processing system;
removing a performance module from the database query processing system;
reconfiguring a server configured to operate as a user module to operate as a performance module; and
reconfiguring a server configured to operate as a performance module to operate as a user module.

16. The database query processing system of claim 15, wherein, in adding a user module to the database query processing system, the configuration management module is configured to:
discover automatically that a new server has been added to the plurality of servers and that the new server has been configured to operate as a new user module; and
integrate the new user module into a pool of user modules accepting new sessions.

17. The database query processing system of claim 15, wherein, in removing a user module from the database query processing system, the configuration management module is configured to:
receive a command to remove a particular user module from the database query processing system;
remove the particular user module from a pool of user modules accepting new sessions; and
receive, upon completion of any outstanding queries involving the particular user module, acknowledgment from the server that had been configured to operate as the particular user module that the particular user module has been removed from the database query processing system.

18. The database query processing system of claim 15, wherein, in adding a performance module to the database query processing system, the configuration management module is configured to:
discover automatically that a new server has been added to the plurality of servers and that the new server has been configured to operate as a performance module; and
modify, in each user module, a function by which each primitive is assigned to a performance module to include one additional performance module in the plurality of performance modules to which primitives are passed.

19. The database query processing system of claim 15, wherein, in removing a performance module from the database query processing system, the configuration management module is configured to:
receive a command to remove a particular performance module from the database query processing system;
modify, in each user module, a function by which each primitive is assigned to a performance module to include one fewer performance modules in the plurality of performance modules to which primitives are passed; and
receive, upon completion of any outstanding primitives assigned to the particular performance module, acknowledgment from the server that had been configured to operate as the particular performance module that the particular performance module has been removed from the database query processing system.

20. The database query processing system of claim 15, wherein, in reconfiguring a server configured to operate as a user module to operate as a performance module, the configuration management module is configured to:
receive a command to reconfigure a particular server configured to operate as a particular user module to operate as a performance module;
remove the particular user module from a pool of user modules accepting new sessions;
receive, upon completion of any outstanding queries involving the particular user module, acknowledgment from the particular server that the particular user module has been removed from the database query processing system;
reconfigure the particular server to operate as a performance module; and
modify, in each user module, a function by which each primitive is assigned to a performance module to include one additional performance module in the plurality of performance modules to which primitives are passed.

21. The database query processing system of claim 15, wherein, in reconfiguring a server configured to operate as a performance module to operate as a user module, the configuration management module is configured to:
receive a command to reconfigure a particular server configured to operate as a particular performance module to operate as a user module;
modify, in each user module, a function by which each primitive is assigned to a performance module to include one fewer performance modules in the plurality of performance modules to which primitives are passed;
receive, upon completion of any outstanding primitives assigned to the particular server, acknowledgment from the particular server that the particular performance module has been removed from the database query processing system;
reconfigure the particular server to operate as a new user module; and
integrate the new user module into a pool of user modules accepting new sessions.

22. The database query processing system of claim 13, wherein the database includes:
a plurality of column files corresponding to a table, each column file containing one or more fixed-length records so as to eliminate use of a row identifier in accessing records;
a token within a particular column file in the plurality of column files, the token pointing to a data value stored in a dictionary data structure external to the particular column file, the dictionary data structure being capable of storing variable-length data values;
an indexing structure including a plurality of index blocks, at least one index block in the plurality of index blocks including multiple pointers pointing to other index blocks in the plurality of index blocks to enable parallel scanning, by the plurality of processing nodes, of a data set associated with the at least one index block; and
for each of a plurality of fixed-length-record types, an associated predetermined code value to indicate a null row in the table and an associated predetermined code value to indicate an empty row in the table, each predetermined code value occupying the same amount of space within a column file as a fixed-length record of the fixed-length-record type with which that predetermined code value is associated.

23. The database query processing system of claim 22, wherein a plurality of tokens point to a single variable-length data value in the dictionary data structure.

24. The database query processing system of claim 13, wherein the SQL statement includes a join operation joining a first table and a second table and the SQL statement also includes a filtering operation on the first table, each of the first and second tables including rows and columns of data, and the database query processing system is configured, in processing such an SQL statement, to:
create, prior to receiving the SQL statement from the computer over the network, a table-oriented interface for each of the first table and the second table using a create-table statement;
minimize the number of rows retrieved from each of the first and second tables by applying the filtering operation to both the first and second tables; and
execute the join operation between the first and second tables without discarding any rows from either table that were not already discarded as a result of applying the filtering operation to both the first and second tables.

25. The database query processing system of claim 24, wherein the table-oriented interface is capable of interacting with any of a plurality of different front-end database management systems.
